(19) United States
(12) Patent Application Publication
(10) Pub. No.: US 2007/0029528 A1
(43) Pub. Date: Feb. 8, 2007

(54) Compositions and methods for facilitating reaction at room temperature

(75) Inventors: Douglas Bryan Grotjahn, San Diego, CA (US); Daniel A. Lev, Chicago, IL (US)

Correspondence Address: STOUT, UXA, BUYAN & MULLINS LLP, 4 VENTURE, SUITE 300, IRVINE, CA, 92618, US

(73) Assignee: San Diego State University Foundation, San Diego, CA (US)

(21) Appl. No.: 10/552,249

(22) PCT Filed: Apr. 2, 2004
(86) PCT No.: PCT/US04/10280

§ 371 Date: Jul. 27, 2006

Related U.S. Application Data
(60) Provisional application No. 60/460,551, filed on Apr. 4, 2003.

(51) Int. Cl. H01B 1/12

(52) U.S. Cl. 252/500

(57) ABSTRACT

Compositions and methods useful in facilitating or conducting a reaction at effective conditions, such as room temperature (e.g. about 70 degrees F.), utilize a compound including at least two different heteroatoms, and optionally a heterocycle, and a transition metal. The compound is effective in facilitating a variety of reactions including hydrolysis reactions, alcoholysis reactions, aminolysis reactions, carbon dioxide conversion reactions, hydroamination reactions, hydration reactions, and the like.

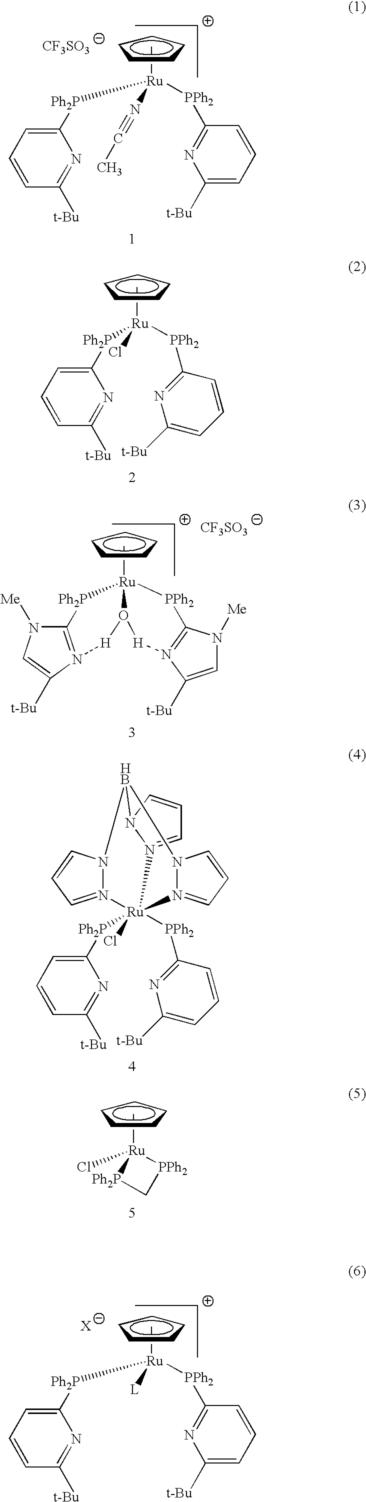

### CROSS-REFERENCE TO RELATED APPLICATIONS

This application claims the benefit of U.S. Provisional Application No. 60/460,551, filed Apr. 4, 2003, the disclosure of which is hereby incorporated by reference.

### BACKGROUND OF THE INVENTION

The present invention relates to compounds or ligands, and compositions and methods utilizing such compounds. More particularly, the invention relates to ligands including first and second heteroatoms, transition metal complexes of such ligands, and methods of using the ligands and complexes, for example, to facilitate or promote chemical reactions, such as hydration of nitrites, and terminal alkynes and alkenes, and the hydrolysis of amides and the like.

Medicinal chemists and biochemists want to know how amino acids are arranged in proteins, so that they can better understand the correlation between structures and the functions of drugs. One of the techniques used to accomplish the task of protein structure determination requires the breaking of amide bonds to liberate the amino acids. However, at physiological temperatures and pH 9, it takes an impractical length of time, for example, 168 years, to break half the amide bonds in a sample. In contrast, organisms found in nature have remarkably efficient systems to make and break amide bonds. Scientists have used natural enzymes such as carboxypeptidase to do the task of amide bond cleavage.

In some cases, it is believed that the crucial step in amide bond cleavage involves proton transfer between imidazole, a carboxylate, and the amide undergoing hydrolysis, while other enzymatic systems involve a metal-catalyzed amide bond cleavage such as that seen in the zinc(II)-metalloprotease. However, existing enzymatic systems can be very complicated and sometimes difficult to handle due to their sensitivity to temperature and pH.

Amide hydrolysis has been catalyzed not only by enzymes, but also by acids, bases, and metal ions. These systems take advantage of one or more possible factors, which facilitate amide bond cleavage. First, the amide bond cleaving reagent or catalyst could act as a proton transfer reagent, which can be an important factor in amide bond hydrolysis. Secondly, a metal may catalyze or mediate amide hydrolysis by acting as a Lewis acid through O-complexation, delivery of a metal-coordinated hydroxide or a combination of the latter two processes.

The importance of nitrile hydration is shown by the industrial hydrolysis of acrylonitrile, which is used to make acrylic acid which, in turn, can be converted to a variety of esters such as methyl, ethyl, butyl, and 2-ethylhexyl acrylates. The acrylates can then be used as co-monomers with methyl methacrylate and/or vinyl acetate to give polymers for water-based paints, among other products. A number of industrial methods exist for obtaining acrylic acids from nitrites and one of the more economical methods is the direct hydrolysis of the acrylonitrile to the acrylic acid. However, this synthetic route involves the use of a stoichiometric amount of sulfuric acid to produce the acrylamide sulfate, which is then treated with an alcohol to give the acrylic ester. It would be advantageous to provide a direct route from the acrylonitrile and alcohol to yield the desired acrylate without the need to use and then neutralize a strong acid by using, for example, an efficient reaction facilitator, e.g., a catalyst.

An example of an environmentally desirable method of conducting organic synthesis involves the addition reactions of water or amines to unsaturated hydrocarbons. For example, the metal-catalyzed hydration of alkynes is an important route to carbonyl compounds. The use of water in such syntheses has the additional advantages of ease of use, safety, and economic savings. Most metal-catalyzed hydrations of 1-alkynes follow Markovnikov addition to give ketones. In addition, as petroleum resources dwindle and the need to control the emissions of carbon dioxide into the environment increases, use of carbon dioxide as a feedstock becomes more desirable. It would be advantageous to provide new materials which are useful to facilitate carbon dioxide conversion, for example, to carbonates, carbamates and ureas.

Anti-Markovnikov addition of water to alkynes has been reported which produces aldehydes and a small amount of ketones. See, for example, Tokunaga, M., et al. Angew. Chem. Int. Ed., 37(20), 2867-2869 (1998); JP 11319576. These catalytic reactions occur at elevated temperatures, for example, at 100 to 130 degrees C. for 12 to 24 hours. Maintaining an elevated temperature for the duration of these reactions can require a substantial amount of energy.

What is needed are reaction facilitators, e.g., catalysts, promoters and the like, that mimic enzymatic systems in their hydrogen-bonding and/or proton transfer abilities, and are robust, simple to handle, easily produced and operate efficiently at room temperature.

### SUMMARY OF INVENTION

New organic ligands, transition metal complexes including such ligands and methods for using the ligands and complexes have been discovered. The present ligands and transition metal complexes can be produced using relatively straightforward synthetic chemistry techniques. Moreover, the structures of the present ligands and metal complexes can be effectively selected or even controlled, for example, in terms of proton transfer ability and/or hydrogen bonding ability, thereby providing ligands and complexes with properties effective to facilitate one or more chemical reactions. Thus, the present metal complexes can be effectively used to facilitate, for example, catalyze, promote, and the like, various chemical reactions, such as hydrolysis, alcoholysis, aminolysis, carbon dioxide conversion, hydroamination and hydration reactions. Importantly, at least some of the present ligands and transition metal-ligand complexes are effective to catalyze such reactions efficiently at room temperature, such as temperatures between about 68 and about 77 degrees Farenheit or between about 20 and about 25 degrees Celsius, for example, about 70 degrees Farenheit.

In one broad aspect of the present invention, compositions are provided which comprise at least one organic ligand and a transition metal partially complexed by the organic ligand.

The present organic ligands include a first heteroatom and a second heteroatom. The first and second heteroatoms may be covalently bonded to each other or, in a preferred embodiment, are separated one from the other by at least one atom, for example, a carbon atom. When the present organic ligands are complexed to a transition metal, one or both of the first and second heteroatoms may be covalently bonded to the transition metal. In particular, each of the first and second heteroatoms presents a lone pair of electrons that can be free (unbonded), protonated, occasionally or temporarily bonded to an aforementioned transition metal, e.g., through a coordinate covalent bond, or hydrogen bonded to a second molecule, e.g., water. This variability in functionality affords the desired cooperativity sought in a ligand of the invention, especially whenever catalytic activity is desired.

Representative organic ligands in accordance with the present invention are shown by the following structures, wherein “R₁” is selected from hydrogen or alkyl or aryl. In a particularly useful embodiment, R¹ is t-butyl. X is a heteroatom which may be, for example, a nitrogen atom (N), an oxygen atom (O), or a sulfur atom (S). In one particularly useful embodiment, X is a phosphorus atom (P).

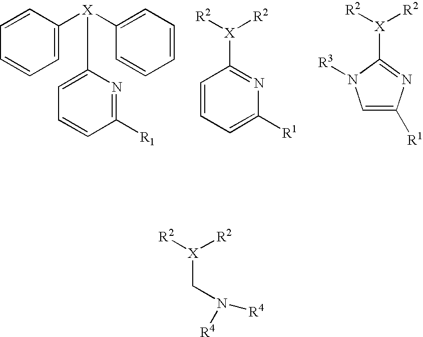

The present organic ligands can be very effectively structured and adapted to control the proton transfer ability and/or hydrogen bonding ability of the transition metal complex of which the ligand is a part. In other words, the present ligands can be selected to obtain the desired degree of proton transfer ability and/or hydrogen bonding ability so that the resulting transition metal complex is highly effective in performing a desired chemical transformation, for example, hydrolysis, alcoholysis, aminolysis, carbon dioxide conversion, and addition of water, alcohols, ammonia or amines to alkenes and alkynes. Such reactions are typically performed by a cooperativity between one heteroatom binding the transition metal and a second heteroatom of the ligand performing H atom transfers with one or more reactants.

In an additional broad aspect of the present invention, methods for reacting alkenes or alkynes with water, alcohols, ammonia or amines are provided. Such methods comprise contacting the reactants in the presence of a transition metal complex of the invention in an amount effective to facilitate the desired reaction to one or more desired products. The contacting occurs at effective reaction conditions. In a particularly preferred method, terminal alkynes are catalytically converted to aldehydes with high selectivities at or near neutral pH.

Each feature and combination of two or more features described herein are included within the scope of the present invention provided that any two features of any such combination are not mutually inconsistent or incompatible.

These and other aspects and advantages of the present invention are set forth in the following detailed description, examples and claims.

### BRIEF DESCRIPTION OF THE DRAWINGS

FIG. 1 is an illustration of five compounds comprising a complex of heteroatoms, a heterocycle, and a transition metal.

FIG. 2 is a graph illustrating the percent conversion of an alkyne to a hydrated form as a function of time for compound 1 of FIG. 1.

### DETAILED DESCRIPTION

The present invention relates to ligands, transition metal complexes including the ligands, and methods of using the ligands and transition metal complexes.

Ligands or compounds of the invention may include a first heteroatom which may be located one carbon atom away from a second heteroatom. Exemplary heteroatoms include nitrogen atoms (N), oxygen atoms (O), sulfur atoms (S) phosphorus atoms (P), arsenic atoms (As), and antimony atoms (Sb). In one particularly useful embodiment of the invention, at least one of the first and second heteroatoms is a nitrogen atom (N).

In one embodiment, an organic ligand of the invention includes at least one nitrogen heterocycle, for example, a substituted or unsubstituted six-membered heterocycle. For example, one or more substituted or unsubstituted pyridine rings or groups or imidazole rings or groups may be included in a ligand.

In one aspect, a ligand of the invention may be neutral in charge. The ligand may join two or more heteroatoms separated by at least one intervening atom. At least one of the heteroatoms may bind to a transition metal with another heteroatom substantially free to interact with one or more reactant molecules or intermediates in the catalytic reaction, e.g., water or alkyne. Such ligands are conveniently but not only provided by covalently linking one or more heterocyclic ring(s) to one or more heteroatom(s) outside the ring. The heteroatom(s) outside the first heterocycle can also be present in a ring structure or not present in a ring structure.

In one useful embodiment, a ligand covalently links a nitrogen containing heterocycle (e.g., an N heterocycle) with a phosphorous heteroatom outside the heterocyclic ring. A ligand may covalently link one or more phenyl, heteroryl, or alkyl groups with a heteroatom, for example, a phosphorous heteroatom, outside the heterocyclic ring. In one embodiment, a ligand covalently links an N heterocyle and one or more phenyl groups, for example, to two phenyl groups with a phosphorous heteroatom outside the heterocyclic ring.

A transition metal of the present invention may be partially complexed by at least one of the present organic ligands. The transition metal may be a metal selected from Group 1B metals, Group IIB metals, Group IIIB metals, Group IVB metals, Group VB metals, Group VIB metals, Group VIIB metals and Group VIIIB metals. Preferably, the transition metal is selected from chromium, manganese, iron, cobalt, nickel, copper, zinc, zirconium, niobium, molybdenum, ruthenium, rhodium, palladium, silver, hafnium, tantalum, tungsten, rhenium, osmium, iridium, platinum and gold. In one particularly useful embodiment, the transition metal is ruthenium. In one embodiment, ruthenium is a transition metal useful for alkyne hydration.

One particularly useful transition metal complex of the present invention is shown by the following structures, wherein “R₁” and “R₂” are independently selected from hydrogen or alkyl or aryl. In a particularly useful embodiment, R₁ and R₂ are t-butyl. R₃ may be a hydrogen, alkyl, aryl, halide, water, alcohol, amine, nitrile or derivatives thereof. In one embodiment, R₃ is a nitrile, for example, an acetonitrile. X is a heteroatom which may be for example, a nitrogen atom (N), an oxygen atom (O), a sulfur atom (S), an arsenic atom (As), or an antimony atom (Sb). The chemical bonds to the one or more heteroatoms present in the transition metal complex would be appropriate for each particular heteroatom present in the transition metal complex. In one particularly useful embodiment, X is a phosphorus atom (P). In addition, the transition metal shown in the following structures is attached to a ligand or ligands L, which can be selected from compounds such as halide ion(s), nitrile(s), alkene(s), phosphine(s), carbon monoxide(s), arenes (such as benzene), or tris(pyrazolyl)borate derivatives. In a particularly useful embodiment, the ligand L is a derivative of cyclopentadienyl anion, such as C₅H₅ itself, or substituted derivatives thereof. In an especially useful embodiment, the ligand L is C₅H₅.

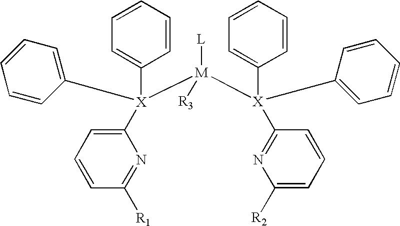

The present transition metal complexes preferably are soluble in the liquid medium in which such complexes are present or are used. The organic ligands may include one or more substituents, for example, one or more polar substituents and/or non-polar substituents, effective to increase the solubility of the ligand/transition metal complex in a certain liquid medium. In addition, the present compositions may include one or more other or additional components, such as silver or thallium salts, acids, bases and the like, in an amount effective to interact with or otherwise affect the complex, for example, to activate the complex and/or to enhance the activity of the complex to facilitate a desired chemical reaction.

The present invention includes within its scope the present ligands and complexes as described herein and any and all substituted counterparts thereof. For example, unless otherwise expressly disclosed to the contrary, one or more of the hydrogen (H) substituents included in the present ligands can be replaced by another monovalent radical, such as a hydrocarbyl radical. Such substituted ligands, as well as the ligands with the hydrogen substituents, are included within the scope of the present invention. In addition, any and all isomers, tautomers, enantiomers, and mixtures thereof of the present ligands are included within the scope of the present invention.

Examples of monovalent radicals that may be included as substituents in the present ligands, for example, as the R groups, include, but not limited to, monovalent hydrocarbon or hydrocarbyl groups, such as alkyl, alkenyl, alkynyl, aryl, alkyl aryl, alkenyl aryl, alkynyl aryl, aryl alkyl, aryl alkenyl, aryl alkynyl and cyclic monovalent hydrocarbon groups; halo such as F, Cl, Br and I; NH₂; NO₂; alkoxy; alkylthio; aryloxy; arylthio; alkanoyl; alkanoyloxy; aroyl; aroyloxy; acetyl; carbamoyl; alkylamino; dialkylamino; arylamino; alkylarylamino; diarylamino; alkanoylamino; alkylsulfinyl; alkylsulfenyl; alkylsulfonyl; alkylsulfonylamido; azido; benzyl; carboxy; cyano; guanyl; guanidino; imino; phosphinyl; silyl; thioxo; uredido or vinylidene or where one or more carbon atoms are replaced by one or more other species including, but not limited to, N, O, P, or S.

The present invention includes methods for producing a hydrolysis product. Such methods comprise contacting a hydrolysis reactant in the presence of a composition in accordance with the present invention in an amount effective to facilitate the hydrolysis of the hydrolysis reactant to the hydrolysis product. This contacting occurs at effective hydrolysis conditions. Such hydrolysis reaction conditions vary widely depending on many factors, such as the reactants and complex being employed, the concentrations of the reactants and complex, the desired product and other factors. However, such reaction conditions are not of critical importance in the present invention and may be selected from conditions conventionally used in similar reactions. Therefore, a detailed presentation of such conditions is not set forth herein.

The hydrolysis reactant preferably is selected from compounds including amide bonds, nitriles, phosphate esters, and cyanide ions.

Compounds including amide bonds which may be hydrolyzed in accordance with the present invention include, but are not limited to, formamide, acetamide, N-methylacetamide, N,N-dimethylacetamide, N,N-diethylacetamide, propionamide, N-methylpropionamide, N,N-dimeethylpropionamide, N,N-diethylpropionamide, butyramide, N-methylbutyramide, N,N-dimethylbutyramide, acrylamide, N-methylacrylamide, N,N-dimethylacrylamide, benzamide, N-methylbenzamide, N,N-dimethylbenzamide, N,N-diethylbenzamide, o-, m-, and p-toluamides and their N-alkylated derivatives, acetanilide, o-, m-, and p-acetotoluidides, 2-acetamidophenol, 3-acetamidophenol, 4-acetamidophenol, N-acylated amino acids, glycylglycine, alanylalanine, and other polypeptides and proteins.

Nitriles which may be hydrolyzed in accordance with the present invention include, but are not limited to, linear or branched saturated alphatic C₂-C₁₈ mono- and C₃-C₁₉ dinitriles and phenyl derivatives thereof, C₄-C₁₃ saturated alphatic mono- and C₅-C₁₄ dinitriles, C₃-C₁₁ linear or branched olefinically unsaturated alphatic nitriles, C₆-C₁₃ olefinically unsaturated alicyclic nitriles, C₇-C₁₄ aromatic mono- and dinitriles C₆-C₈ heterocyclic nitrogen and oxygen mononitriles, C₃-C₄ cyanoalkanoic amides, C₂-C₁₂ saturated aliphatic cyanohydrins or hydroxynitriles, and mixtures of the above-described nitriles.

Specific examples include, but are not limited to, acetonitrile, propionitrile, buytronitrile, acrylonitrile, benzonitrile, and substituted derivatives.

Phosphate esters which may be hydrolyzed in accordance with the present invention include, but are not limited to, trialkyl phosphates, triaryl phosphates, dialkyl aryl phosphates, alkyl diaryl phosphates, dialkyl phosphates including DNA and RNA derivatives, diaryl phosphates, alkyl aryl phosphates, alkyl phosphates, aryl phosphates, and analogous phosphonic acid derivatives.

Further, the present invention includes methods for converting carbon dioxide. Such methods comprise contacting carbon dioxide in the presence of a composition in accordance with the present invention in an amount effective to facilitate the conversion of the carbon dioxide to a conversion product. The contacting occurs at effective carbon dioxide conversion conditions. Such reaction conditions vary widely depending on many factors, such as the complex being employed, concentrations of the carbon dioxide and complex, the desired product and other factors. However, such conditions are not critical in the present invention and may be selected from conditions conventionally utilized in similar carbon dioxide conversion reactions. Therefore, a detailed presentation of such conditions is not set forth here.

The carbon dioxide conversion product preferably is selected from ureas, carbamates and carbonates.

Another group of chemical reactions facilitated by the present metal complexes is illustrated by the reaction of alkenes or alkynes with water to produce the corresponding alcohol or aldehyde, respectively.

Without wishing to limit the invention to any particular theory of operation, representative reactions and conditions for the hydration of terminal alkynes are set forth below:

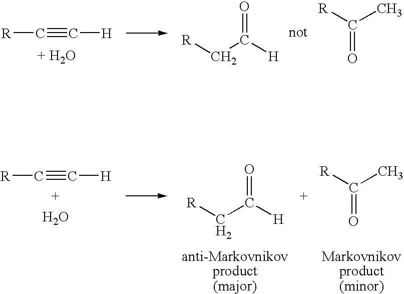

Surprisingly, ligands of the present invention are capable of efficiently performing this reaction at room temperature, such as at a temperature between about 68 degrees Farenheit and about 77 degrees Farenheit.

The present ligands can be produced from inexpensive and readily available materials, using chemical synthesis techniques well known in the art.

The following non-limiting examples illustrate certain aspects of the present invention.

### EXAMPLE 1

### Production of [Cyclopentadienylruthenium(II) bis(2-diphenylphosphino-6-t-butylpyridine) (acetonitrile)][X]

5 mL of dry, deoxygenated methylene chloride was added to a 50-mL Schlenk flask containing 0.70 mmol of [cyclopentadienyl ruthenium(II) tris(acetonitrile)] [X] (X=PF₆⁻ or CF₃SO₃⁻¹) under nitrogen. 5 ml of a solution containing 446 mg or 1.40 mmol of 2-diphenylphosphino-6-t-butylpyridine in dry, deoxygenated methylene chloride was added to the flask and the mixture was stirred for 5 h at room temperature. The solvents were removed under high vacuum leaving behind a yellow solid. The solid was washed with 5 mL of deoxygenated pentane two times and then dried under high vacuum producing a yellow microcrystalline powder.

X=PF₆⁻, 685 mg, 0.69 mmol, 99%. Data for the PF₆⁻¹, salt: ¹H NMR (CDCl₃, 500 MHz) δ 7.44 (tt, J=8.0, 1.7 Hz, 2 H), 7.42-7.36 (m, 4 H), 7.31-7.35 (m, 4 H), 7.30 (dq, J=8.0, 1.1 Hz, 2 H), 7.26 (t, J=7.5 Hz, 4 H), 7.13-7.18 (m, 8 H), 6.65 (dm, J=7.5 Hz, 2 H), 4.46 (t, J=1.0 Hz, 5 H), 2.21 (t, J=1.2 Hz, 3 H), 1.33 (s, 18 H) ppm. Selected ¹³C{¹H} NMR data (CDCl₃, 125 MHz) δ 169.7 (vt, N_{CP}=14.0 Hz), 135.0 (vt, N_{CP}=10.4 Hz), 133.8 (vt, N_{CP}=9.4 Hz), 130.3, 129.9, 129.4, 128.2 (vt, N_{CP}=9 Hz), 128.1 (vt, N_{CP}=9 Hz), 125.1 (vt, N_{CP}=21 Hz), 119.2, 83.0 (t, J_{CP}=1.9 Hz), 38.2, 30.3, 4.51 ppm. For phosphines: ³¹P {¹H} NMR (CDCl₃, 200 MHz) δ 41.46 ppm. IR (NaCl, CDCl₃) 3063, 2967, 2867, 2271, 1711, 1575, 1558, 1480, 1436, 1385, 1361, 1187, 1168, 1145, 999, 988 cm¹. 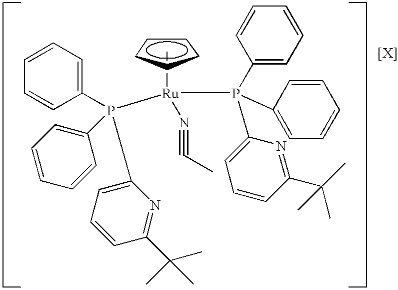
[Cyclopentadienylruthenium(II) bis(2-diphenylphosphino-6-t-butylpyridine) (acetonitrile)][X]

### EXAMPLE 2

### Hydration of 1-Nonyne Utilizing [Cyclopentadienylruthenium(II) bis(2-diphenylphosphino-6-t-butylpyridine) (acetonitrile)][X]

A 2-mL vial was charged with 0.0100 mmol of [Cyclopentadienylruthenium(II) bis(2-diphenylphosphino-6-t-butylpyridine) (acetonitrile)][X], 0.500 mmol of 1-nonyne and 0.0500 mL hexadecane. A solvent system, either 3:1 (v/v) i-propanol/water or acetone with 2.50 mmol water, was then added such that the total final volume was 1.00 mL. The reaction was then heated in a 96-well monoblock heating apparatus. Periodically, 0.0100 mL samples were removed from the reaction mixture, diluted with acetone, and monitored using gas chromatography and an FID detector. Hydration product concentrations were determined using FID response factors calculated from standard solutions.

### EXAMPLE 3

### Comparison of Initial Rates of the Hydration of 1-Nonyne and Phenylacetylene by Certain Catalysts

Comparison of Initial Rates of the Hydration of 1-Nonyne

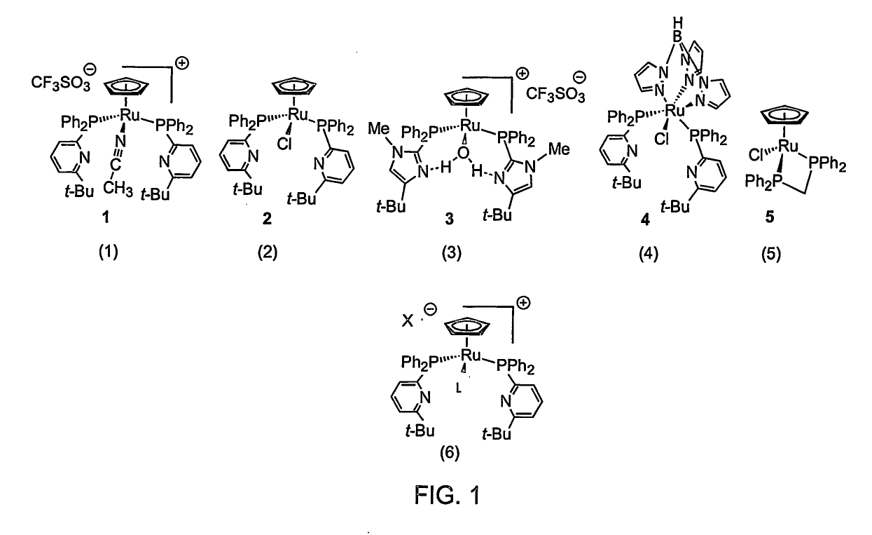

Hydration rates of an alkyne were examined for five compounds, as shown in FIG. 1. Each compound is identified for convenience as (1), (2), (3), (4), or (5). Compound 5 has been previously reported by others in the literature (Suzuki, Tokunaga, and Wakatsuki, Org. Lett. 2001, 3, 735-737). Compound 3 was previously described in Angew. Chem., Int. Ed. Engl. 2001, 40, 3884-3887 disclosed in pending U.S. patent application Ser. No. 09/785,911, filed Feb. 16, 2001, which is incorporated in its entirety herein by reference.

Rates are expressed as % conversion per % catalyst per hour

| | | Iso-propanol/ |
|---|---|---|
| | Acetone @ | H₂O (3:1 v/v) |
| Catalyst | 70° C. | @ 70° C. |
| 2% CpRu(Ph₂PtButPyr)₂(CH₃CN)⁺ (1) | 23.6235 | 36.0595 |
| 2% CpRu(Ph₂PtButPyr)₂Cl (2) | 2.44825 | nd |
| 2% CpRu(Ph₂PtButImid)₂(H₂O)⁺ (3) | 1.8807 | nd |
| 2% TpRu(Ph₂PtButPyr)₂Cl (4) | 0.8175 | nd |
| 2% CpRu(dppm)Cl (5) | 0.0206 | 0.03442 |

Comparison of Initial Rates of the Hydration of Phenylacetylene

| Catalyst | Acetone @ 70° C. |
|---|---|
| 2% CpRu(Ph₂PtButPyr)₂(CH₃CN)⁺ (1) | 5.8535 |
| 2% CpRu(Ph₂PtButPyr)₂Cl (2) | 1.8876 |
| 2% CpRu(Ph₂PtButImid)₂(H₂O)⁺ (3) | nd |
| 2% CpRu(dppm)Cl (5) | nd |

These data demonstrate the exceptional ability of catalyst 1 to perform an anti-Markovnikov hydration of terminal alkynes to aldehydes relative to other catalysts analyzed.

Catalyst 5 is a very exceptional catalyst previously reported by others in the literature (Suzuki, Tokunaga, and Wakatsuki, Org. Lett. 2001, 3, 735-737). Note that catalyst 1 hydrates nonyne at least 1000 times faster than catalyst 5, whether the reaction is performed in iso-propanol/H₂O (3:1 v/v) or in acetone containing 5 equiv of water.

In addition, catalyst 6 appears to be effective in facilitating the reactions disclosed herein. As shown in FIG. 1, L of catalyst 6 refers to any ligand, such as the ligands disclosed herein, and X⁻ refers to any anion, such as the anions disclosed herein.

### EXAMPLE 4

### Comparison of Initial Rates of the Hydration of 1-Nonyne

Comparison of the initial rates of hydration of 1-nonyne at room temperature by: 1) 2% CpRu(Ph₂PtButPyr)₂(CH₃CN)⁺, in acetone plus 5 equivalents of H₂O; 2) 5% CpRu(Ph₂PtButPyr)₂(CH₃CN)⁺, in acetone plus 5 equivalents of H₂O; 3) 2% CpRu (Ph₂PtButPyr)₂(CH₃CN)⁺, in an iso-propanol/H₂O solution (3:1 v/v); 4) CpRu(Ph₂PtButImid)₂(H₂O)⁺ in acetone plus 5 equivalents of H₂O; and 5) CpRu(dppm)Cl in acetone plus 5 equivalents of H₂O are shown below.

TABLE 1
Room-temperature hydration of 1-nonyne^{a}

| Time | 2 mol % 1 | 5 mol % 1 | 2 mol % 1^{b} | 2 mol % 3 | 2 mol % 5 |
|---|---|---|---|---|---|
| (h) | CpRu(Ph₂PtButPyr)₂(CH₃CN) | CpRu(Ph₂PtButPyr)₂(CH₃CN) | CpRu(Ph₂PtButPyr)₂(CH₃CN) | CpRu(Ph₂PtButImid)₂(H₂O)⁺ | CpRu(dppm)Cl |
| 0 | 0 | 0 | 0 | 0 | 0 |
| 5.5 | 13.6 | 30.2 | 8.8 | 0 | 0 |
| 8 | nd | nd | nd | 0 | 0 |
| 19 | 36.0 | 65.5 | 26.7 | 0 | 0 |
| 48 | 56.6 | 98.6 | 51.5 | 0 | 0 |
| 96 | nd | nd | nd | <1% | 0 |

^{a}Unless otherwise indicated, solvent was acetone plus 5 equivalents of H₂O.
^{b}Solvent was i-PrOH—H₂O (3:1 v/v).
The catalysts are numbered in bold and correspond to catalysts 1 to 5 in Example 3.

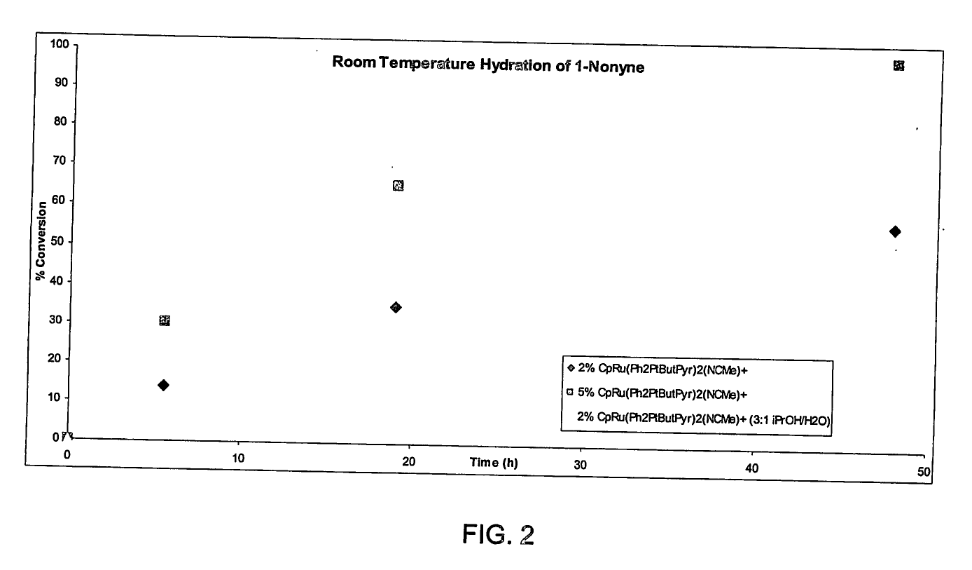

The graph of FIG. 2 shows the hydration of 1-nonyne at room temperature by: 1) 2% CpRu(Ph₂PtButPyr)₂(CH₃CN)⁺ in acetone plus 5 equivalents of H₂O; 2) 5% CpRu(Ph₂PtButPyr)₂(CH₃CN)⁺ in acetone plus 5 equivalents of H₂O; and 3) 2% CpRu (Ph₂PtButPyr)₂(CH₃CN)⁺ in an iso-propanol/H₂O solution (3:1 v/v).

Referring to Table 1, the following chemical formulas correspond to the compound or catalyst of Example 3 as follows:
CpRu(Ph₂PtButPyr)₂(CH₃CN)⁺=catalyst 1 in Example 3
CpRu(Ph₂PtButImid)₂(H₂O)⁺=catalyst 3 in Example 3
CpRu(dppm)Cl=catalyst 5 in Example 3

Based on the data in this example, it can be seen that the CpRu(Ph₂PtButPyr)₂(CH₃CN)⁺ catalyst is effective to efficiently hydrate 1-nonyne. More than 98% of 1-nonyne is hydrated within a 48 h period when reacted in the presence of 5% CpRu(Ph₂PtButPyr)₂(CH₃CN)⁺ in acetone plus 5 equivalents of H₂O.

While this invention has been described with respect to various specific examples and embodiments, it is to be understood that the invention is not limited thereto and other embodiments are within the scope of the invention.

What is claimed is:

1. A compound useful for facilitating a reaction, comprising at least two different heteroatoms selected from the group consisting of N, P, S, O, As, and Sb, and a transition metal, wherein the compound is effective to facilitate a reaction at effective conditions within about 96 hours from being combined with a reactant.

2. The compound of claim 1, further comprising a heterocycle.

3. The compound of claim 1 wherein the different heteroatoms are P and N.

4. The compound of claim 1, further comprising a heterocycle, and wherein one or more N atoms are provided in the heterocycle.

5. The compound of claim 1 wherein the heterocycle is a substituted or unsubstituted pyridine group.

6. The compound of claim 1 wherein the heterocycle is a substituted or unsubstituted imidazole group.

7. The compound of claim 1 further comprising a substituted or unsubstituted phenyl or alkyl group.

8. The compound of claim 1, wherein the transition metal is selected from the group consisting of Group 1B metals, Group IIB metals, Group IIIB metals, Group IVB metals, Group VB metals, Group VIB metals, Group VIIB metals and Group VIIIB metals.

9. The compound of claim 1 wherein the transition metal is selected from the group consisting of Ru and Pt.

10. The compound of claim 1 wherein the compound is effective to facilitate a hydration reaction.

11. The compound of claim 1 wherein the compound is effective to facilitate a hydrolysis reaction.

12. The compound of claim 1 wherein the compound is effective to facilitate a reaction at room temperature.

13. The compound of claim 1 having the formula

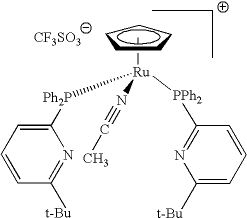

14. The compound of claim 1 having the formula 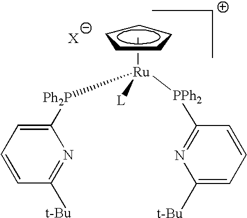
wherein X is an anion and L is a ligand.

15. The compound of claim 1 wherein the compound is effective to facilitate an addition reaction of an amine, an alcohol or water to an alkene.

16. A composition for facilitating a reaction at room temperature, comprising the compound of claim 1.

17. The composition of claim 16, further comprising an alkene reactant or an alkyne reactant, and water, wherein the compound is effective in facilitating hydration of the alkene reactant or the alkyne reactant at room temperature.

18. A method of conducting a reaction, comprising:
contacting a compound comprising a complex of (i) at least two different heteroatoms selected from the group consisting of N, P, S, O, As, and Sb, and (ii) a transition metal, with a reactant at conditions, including room temperature, effective to facilitate a reaction of the reactant, thereby forming a product of the reaction within about 96 hours from when the compound and the reactant were first contacted.

19. The method of claim 18, wherein the compound further comprises a heterocycle.

20. The method of claim 18, wherein the reactant is an alkyne or an alkene, and the compound is effective in facilitating hydration of the alkyne or the alkene at room temperature.

21. The method of claim 20, wherein the reactant is an alkyne, and the contacting is effective to hydrate about 98% of the alkyne within about 48 hours.

22. The method of claim 18, wherein the compound has the formula

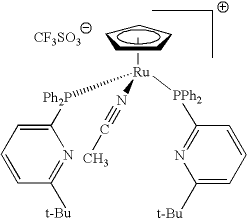

23. The method of claim 18, wherein the compound has the formula

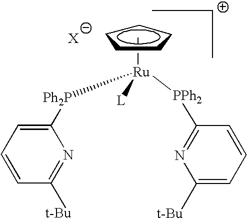

24. The method of claim 18, wherein the compound is effective in facilitating an addition reaction of an amine, an alcohol or water to an alkene.

25. The method of claim 18, wherein the compound is effective in facilitating a hydrolysis reaction.

26. The method of claim 18, wherein the compound and the reactant are contacted at a temperature of about 70 degrees Farenheit.

27. The method of claim 18, further comprising a step of determining a quantity of the reactant that has been converted to the product.
